(19) United States
(12) Patent Application Publication
(10) Pub. No.: US 2009/0235818 A1
(43) Pub. Date: Sep. 24, 2009

(54) REMOVAL OF ELEMENTAL MERCURY FROM GAS BY MODIFYING WET SCRUBBER SYSTEMS WITH AN ORGANIC COMPOUND

(76) Inventor: Carl E. Hensman, Seattle, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/253,495

(22) Filed: Oct. 17, 2008

Related U.S. Application Data
(63) Continuation of application No. 12/040,681, filed on Feb. 29, 2008, now abandoned.
Application No. 12/040,681 is a continuation of application No. 11/132,682, filed on May 19, 2005, now abandoned.
(60) Provisional application No. 60/572,880, filed on May 19, 2004.

(51) Int. Cl. B01D 47/05

(52) U.S. Cl. 95/152; 95/234; 95/195

(57) ABSTRACT

A method of removing elemental mercury from gas phase fluids by contacting the gas with an organic compound dissolved in a gas scrubbing liquid.

### TECHNICAL FIELD

This application claims the priority of provisional application Ser. No. 60/572,880, filed May 19, 2004 by Carl E. Hensman entitled Removal of Volatile Metals from Gaseous Fluids by Modifying Wet Scrubber Systems with an Organic Ligand and Iron.

This invention relates to a novel application of a material to remove elemental mercury from gas. The gas may be gaseous emissions prior to the discharge of the emissions to the environment or prior to its entry into any cleaning device, industrial process gases, gases produced during natural resource recovery, or naturally produced gases. The elemental mercury may be present in a volatile form or be present as, or bound to, a particle. The application involves the addition of a mercury binding organic compound to the aqueous phase of any wet gas-scrubbing system, in place, or being installed to clean the gaseous emissions prior to the discharge of the emissions to the environment, the industrial process gases, the gases produced during natural resource recovery, or the naturally produced gases.

### BACKGROUND OF THE INVENTION

The present invention is drawn generally to a process for enhancing air quality and restoring the environment through the removal of elemental mercury from gases released to or present in the atmosphere. While this invention will work for all insoluble toxic metals in a gas, of specific interest is elemental mercury.

It is estimated that 144-189 Megagrams (158-207 tons) of mercury are emitted annually into the atmosphere by anthropogenic sources in the United States (Keating, 1997; NADP Mercury Deposition Network). Approximately 87 percent of the mercury is from combustion point sources and 10 percent from manufacturing-point sources. The combustion point sources can be broken down further into four major classes, coal-fired utility boilers, municipal waste combustion, commercial/industrial boilers and medical waste incinerators, Table 1. All of these are high-temperature waste combustion or fossil fuel processes. In each case the mercury is an impurity in the fuel or feedstock and is volatilized due to the low mercury boiling point and discharged to the atmosphere with the flue gas. Even though mercury is a proportionately minor impurity, the large quantity of fuel or feedstock used results in massive mercury discharges.

In an ideal situation, mercury would not be in the raw materials used in the processes described above, thus negating the concern of mercury emission. Unfortunately, it is not currently feasible to remove the trace mercury before it enters the process. Industry has started to contemplate removing the impurities during the manufacturing cycle; however, the easiest location for mercury capture is still flue gas discharges.

Wet scrubbing is currently used in 20-30% of US coal-fired plants. The wet scrubbing systems are designed mainly for solid particle or SO_{X} removal. A typical system sprays water counter-current into the flue gas, particulates or SO_{X} are captured by the scrubber water which then goes to a separation system to remove particulates or SO_{X}. As a serendipitous benefit, organic and inorganic materials easily dissolved in water (e.g. HgCl₂) are also partitioned into the scrubber water and removed from flue gas. However, a large fraction of the mercury in flue gas is elemental mercury (Hg⁰), Table 1, and will not be removed by a simple wet scrubbing system, ultimately ending up in the environment. While inorganic mercury itself is not bioaccumulative it is readily converted to a neurotoxin, methyl mercury, in the ambient environment.

Many wet scrubbing technologies are commercially available. However, most address volatile organic compounds (VOC), sulfur oxides (SO_{X}) and particulate matter removal. Nitrogen oxides (NO_{X}) can also be abated by these technologies, but are often addressed through combustion modifications in the process. Toxic metal removal is typically an afterthought or of academic interest. (Okada and Todaka, 1986; Balogh and Liang, 1995; Senba et al., 2001) The US EPA Mercury Study Report to Congress (Keating, 1997) reviewed the mercury removal capabilities of existing air pollution control devices (APCDs), Table 2.

What is required, to address the concerns of this and other studies, is a technology that can remove all forms of mercury and other elemental mercury from flue gases, concurrently allowing the ‘trapped’ Hg to be easily separated from the scrubber water in a form that passes all required Toxicity Characteristic Leaching Procedure (TCLP) control limits. Additionally, the technology should be easily adapted to existing plant equipment, thereby reducing capital and implementation costs.

U.S. Pat. No. 6,328,939 B1 describes mercury removal in utility wet scrubber using a chelating agent (Amrhein, 2001). The patent demonstrates the reduction of elemental mercury exiting a wet scrubber by addition of a chelating reagent. The difference between the present invention and that reported by Amrhein falls to the compounds being used and the mechanistic approach. The Amrhein invention addresses the concern that transition metals purportedly induce an unwanted conversion of dissolved ionic mercury into elemental mercury, which can then be released from the scrubber water. The dissolved ionic mercury is the result of gaseous soluble compounds of mercury dissolving into the scrubber liquid upon contact. The Amrhein invention does not address the problem of the elemental mercury entering the wet scrubber, rather just the reduction of elemental mercury produced from dissolved ionic mercury in the scrubber liquid. In the Amrhein invention, the transition metals in the matrix that convert the dissolved ionic mercury to elemental mercury are complexed by EDTA, before they can complete the mercury transformation, from dissolved ionic to elemental mercury. In the present invention the specific species of mercury targeted is elemental mercury not water soluble mercury. Additionally, the present invention addresses the need to transfer elemental mercury from the gas entering the wet scrubber into the scrubber liquid and render it unavailable to further chemistry. It is demonstrated in FIG. 1 and FIG. 2, that the claims for the present invention are directly related to elemental mercury in a gas, as this is the only species of mercury present. The organic compounds of the present invention are not taught or suggested in this reference.

U.S. Pat. No. 6,503,470 B1 describes an invention in which sulfide ions (S²⁻) are delivered in to the wet scrubber's scrubbing liquid to sequester mercury ions (Nolan et al., 2003). The ions result from water soluble volatile HgCl₂ present in a gas contacting the scrubber water. This differs from the present invention as the present invention removes elemental mercury from the gas and relies upon a chelating organic compound to capture the elemental mercury rather than free S²⁻ ion. It is demonstrated in FIG. 1 and FIG. 2, that the claims for this invention are directly related to elemental mercury in a gas, as this is the only species of mercury present.

U.S. Pat. No. 3,951,790 describes an invention in which an organic compound, Thiuram Polysulfide, is used to remove all forms of mercury from the gas phase (Fukisawa et al., 1976). This teaching differs from the present invention as the gas, containing elemental mercury, is passed through the solid organic compound in the form of a sorbent bed; whereas in the present invention the compound is pre-dissolved in the scrubbing liquid and then the scrubbing liquid is contacted with the elemental mercury containing gas. For clarification, Fujisawa does dissolve the Thiuram polysulfide in water, but only to sequester dissolved mercury already present in the water, not to capture elemental mercury from a gas; in fact a mercury containing gas is never in contact with the water.

### SUMMARY OF THE INVENTION

The disclosed invention relates to a novel application of a material to remove elemental mercury from a gas. The gas may be gaseous emissions prior to the discharge of the emissions to the environment, or industrial process gases, or gases produced during natural resource recovery, or naturally produced gases. The elemental mercury may be present in a volatile form. The elemental mercury may also be present as, or bound to, a particle. The application involves the addition of a mercury binding organic compound to the aqueous phase of any wet gas-scrubbing system, in place, or being installed to clean the gaseous emissions prior to the discharge of the emissions to the environment, the industrial process gases, the gases produced during natural resource recovery, or the naturally produced gases. The mercury binding material is an organic compound from the group consisting of acrylamides, organo-thiols, macrocyclic ligands or derivatives thereof.

All aspects of the present invention contemplate means for removing elemental mercury from a gas by adding the organic compound to the wet scrubber systems aqueous scrubbing fluid supply, and the organic compound addition is independent of the wet scrubber system design or implementation.

### BRIEF DESCRIPTION OF THE DRAWINGS

Table 1. Mercury emissions (in tons) in the USA classed as to point source type and mercury form of emission.

Table 2. Removal of mercury by existing air pollution control devices.

FIG. 1. Experimental schematic for pilot testing of the organic compound addition to scrubber water for the removal of all mercury species.

FIG. 2. The removal of 150 μg/m³ elemental mercury from gas phase due to addition of organo-thiol polymer to gas scrubber water, with activation of the polymer by ferric chloride.

FIG. 3. The removal of 150 μg/m³ elemental mercury, as a function of organo-thiol polymer concentration in gas scrubber water, from gas phase. Activation of the polymer was achieved with the addition of 5 ppm ferric ions.

### BEST MODE FOR CARRYING OUT THE INVENTION

The present invention is directed to a new and improved method for removing elemental mercury from gas. The method consists of adding an organic compound to the liquid used in wet gas-scrubbing systems. Not bound by theory, it is believed that the organic compound transfers the elemental mercury from the gas phase into the scrubber liquid, where the organic compound further complexes the mercury and precipitates it out of solution.

The postulated mechanism for the capture of elemental mercury by the organic compound is an initial gas-liquid surface interaction, where the elemental mercury associates and binds with the terminal groups on the organic compound. The organic compound then becomes neutrally charged and precipitates out of solution transferring the toxic metal into a bound solid form that can be easily separated. The general equation is speculated to be:

Hg⁰_{(g)}+L_{(aq)}→HgL₍ₛ₎

where Hg⁰_{(g)} is the elemental mercury in a gas, L_{(aq)} is the dissolved organic compound in the scrubbing liquid, HgL₍ₛ₎ is the resulting solid precipitate.

The present invention involves the removal of elemental mercury. Of course this is just one example, and the method is expected to find commercial application to all insoluble toxic heavy metals found in a gas phase fluid. Where “heavy metals,” are individual metals, semi-metallic metals, other metals and metal compounds that negatively affect the health of animals. At trace levels, many of these elements are necessary to support life. However, at elevated levels they become toxic, may build up in biological systems, and become a significant health hazard. Although not limited to, as of 14 Apr. 1999 the U.S. Department of Labor, Occupational Safety & Health Administration defined toxic metals as: Aluminum, Antimony, Arsenic, Barium, Beryllium, Bismuth, Boron, Cadmium, Calcium, Chromium, Cobalt, Copper, Hafnium, Iron, Lead, Magnesium, Manganese, Mercury, Molybdenum, Nickel, Osmium, Platinum, Rhodium, Selenium, Silver, Tantalum, Tellurium, Thallium, Tin, Titanium, Uranium, Vanadium, Yttrium, Zinc, Zirconium. The form of these toxic metals in the gas phase are defined as the species of toxic metals present, where the toxic metals may be present as, or bound to, a particulate. The toxic metals may also be present in elemental or ionic form, or associated to, or bound in, a chemical compound.

Scrubber liquid is considered any aqueous or previously modified aqueous phase to which the organic compound will be added. The organic compound is a mercury binding organic compound from the group consisting of acrylamides, organo-thiols, macrocyclic ligands or derivatives thereof.

In its broadest form, the present invention comprises a method for removing mercury from the gas generated during the combustion of fossil fuels or solid wastes through the use of an organic compound able to complex and trap elemental mercury. Of course, while the aforementioned coal-fired utility boiler installations are but one example, and the method of the present invention will likely find commercial application to the removal of mercury from gas produced by such utility boiler installations which combust such fossil fuels, any industrial process using a wet scrubber type of absorber module to purify such gas phase fluids may benefit. Such processes could include incineration plants, waste to energy plants, or other industrial processes which generate gaseous products containing mercury.

It is expected that no additional materials will be required to satisfy this invention. However, in certain cases the compound may require the addition of a metal activator to start the transfer of the elemental mercury from the gas to the scrubber liquid. The activator is defined as any metal that binds with the organic compound and precipitates from the scrubber water. It is expected that an activator will be ubiquitous in commercial use scrubber liquids and will not require material modification.

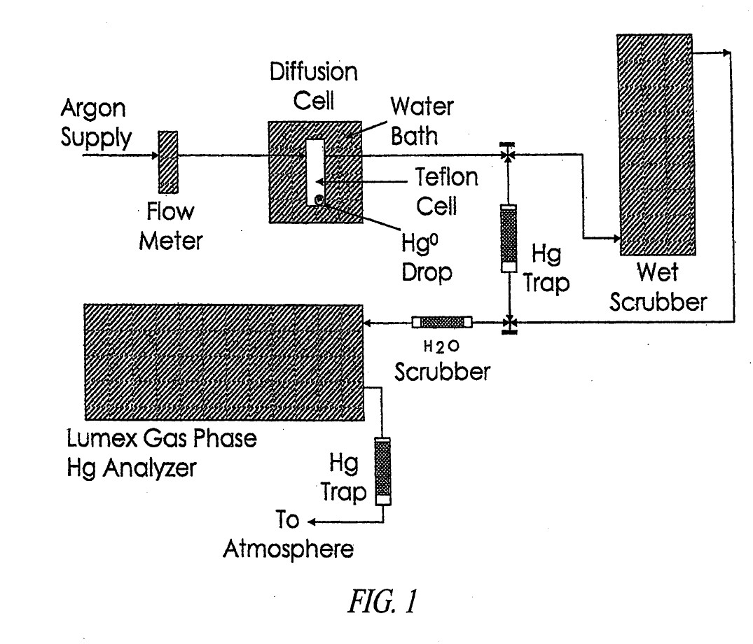

FIG. 1. describes the simulated wet scrubber system design for testing the removal of elemental mercury from gas phase. Argon gas is metered in a Teflon cell containing a calibrated mercury diffusion cell. The Teflon cell is placed in a water bath at 50° C. This results in an emitted gas stream containing −150 μg/m³ of elemental mercury. The gas stream can be directed through a mercury trap, generating a background instrument response to be recorded, or through the pilot wet scrubber. Prior to entering the Lumex portable mercury vapor analyzer (Lumex RA915) the gas passes through a desiccant, just to make sure that no water vapor is present to quench the fluorescence signal. The Lumex is being used in an external cell configuration, thus another mercury trap is placed on the vent to atmosphere.

The wet scrubber is filled with water. The elemental mercury laden gas, described above, is passed into the scrubber system until a steady state is achieved. 10, 50, 100, 250 or 500 ppm of organic compound is added to the scrubber water along with 5 ppm of activator, if required, and the concentration of the total mercury in the emitted gas is measured every 1 second.

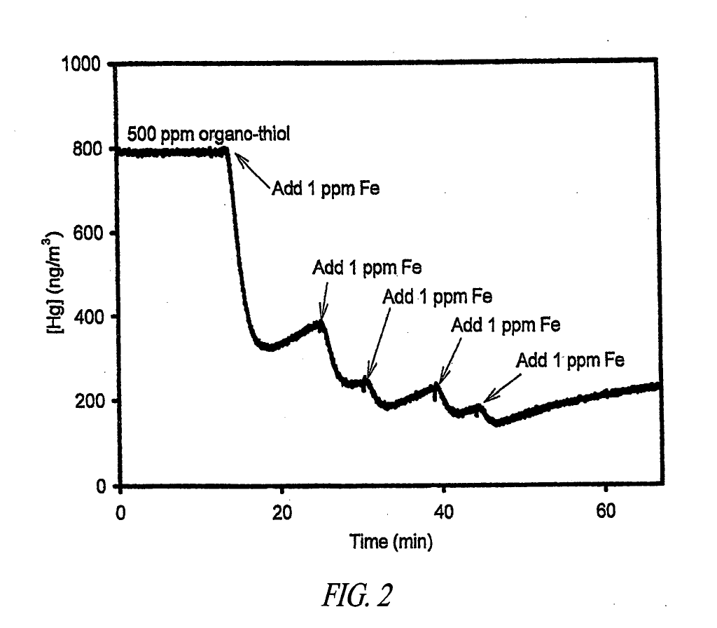

In one example, but not limited to, FIG. 2 shows the mercury removal performance of organo-thiol polymer as the organic complexing compound with activation by Iron(III), added incrementally in 1 ppm aliquots. The activator is required as the scrubber water in this example is initially de-ionized water. At the beginning, the organo-thiol polymer has no impact on the mercury removal efficiency. However, as iron(III) is added to the scrubber water the mercury being detected in the emitted gas decreases significantly. The iron(III) begins a precipitation process of the organo-thiol polymer. During this process the volatile mercury is also bound by the precipitate and removed from the flue gas.

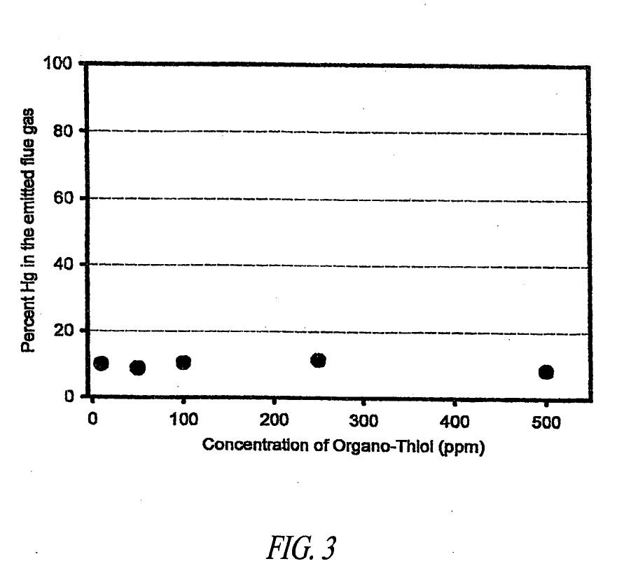

In another example, but not limited to, FIG. 3 demonstrates the effectiveness of the system at various concentrations of organo-thiol polymer with 5 ppm of iron(III) activator. It can be seen that the effectiveness of the organo-thiol polymer is independent of concentration and that a 92% reduction in volatile mercury is achieved.

In all embodiments the organic compound would be added to the wet scrubber systems scrubbing liquid supply. As the organic compound only needs to be added to the scrubbing liquid supply the organic compound addition is independent of wet scrubber system design or implementation, thus it can be applied to any configuration of equipment that constitutes a wet scrubber design, such as, but not limited a flue gas desulfurization system. The method according to the present invention can be easily adapted to an existing, or to-be-constructed, installation using a wet scrubber. The organic compound could be provided from an organic compound delivery system, generally designated, via a line into the wet scrubber liquid. Recirculating pumps continuously pump the scrubber liquid from the lower portion to the upper headers located within an upper portion of the wet scrubber, which spray the scrubber liquid into the gas being treated by the wet scrubber. A person skilled in this art can determine the most effective and economical agent, as well as what quantities to use, and the most effective means of delivery. In any application, the critical feature is to ensure supplying the organic compound to the scrubber liquid used to scrub the gas, in an amount sufficient to reduce the concentration of elemental mercury in the gas that enters the wet scrubber.
Amrhien, G. T.; “Mercury Removal in Utility Wet Scrubber Using a Chelating Agent”, U.S. Pat. No. 6,328,939 B1, 2001.
Balogh, S.; Liang, L.; (1995) “Mercury pathways in municipal wastewater treatment plants” Water, Air, Soil Pollut. 80(1-4) 1181-90.
Fujisawa, T.; Ambe, M.; Kobayashi, N.; Osawa, A.; Shimizu, K; “Thiuram Polysulfide Heavy Metal Remover”, U.S. Pat. No. 3,951,790, 1976.
Keating, M. H. (1997) “An Inventory of Anthropogenic Mercury Emissions in the United States”, US EPA Mercury Study Report to Congress Volume II: Report# EPA-452/R-97-004”.
NADP Mercury Deposition Network, http://nadp.sws.uiuc.edu/mdn/.
Nolan, P. S; Downs, W; Bailey, R. T.; Vecci, S. J; “Use of Sulfide-Containing Liquors for Removing Mercury from Flue Gases” U.S. Pat. No. 6,503,470 B1, 2003.
Okada, M.; Todaka, H.; (1986) “Incinerator flue gas scrubbing”, application: JP 84-148594 19840719.
Senba, N.; Asano, M.; Kanta. K.; Nishizawa, T.; (2001) “Apparatus and method for treatment of industrial wastewaters from wet scrubbing of incinerator flue gases” application: JP 99-317485 19991108.

TABLE 1
Mercury emissions (in tons) in the USA classed as
point source type and mercury form of emission.

| | Elemental | | Oxidized | | Particulate | | Total | |
|---|---|---|---|---|---|---|---|---|
| Sources | Mercury | | Mercury | | Mercury | | Mercury | |
| Coal | 38 | | 23 | | 15 | | 76 | (45%) |
| Burning | | | | | | | | |
| Incinerators | 11 | | 33 | | 11 | | 55 | (33%) |
| Other Point | 24 | | 4 | | 2 | | 30 | (18%) |
| Sources | | | | | | | | |
| Area Sources | 7 | | 0 | | 0 | | 7 | (4%) |
| Total | 80 | (48%) | 60 | (36%) | 28 | (16%) | 168 | |

TABLE 2
Removal of mercury by existing air pollution control devices.

| | Hg Removal % | Mean Hg | |
|---|---|---|---|
| Control Device | Range | Removal % | % RSD |
| Flue gas | 0.00-61.67 | 30.85 | 73.16 |
| desulfurization (FGD) | | | |
| Spray Dryer Adsorption | 0.00-54.50 | 25.59 | 111.53 |
| (SDA) | | | |
| Fabric Filter (FF) | 0.00-73.36 | 28.47 | 125.08 |
| Electrostatic | 0.00-82.35 | 23.98 | 107.88 |
| Precipitators - Cold | | | |
| Side (ESP-CS) | | | |
| Electrostatic | 0.00-83.00 | 31.17 | 127.51 |
| Precipitators - Hot | | | |
| Side (ESP-HS) | | | |

1. A method of the removal of elemental mercury from gas phase fluids using aqueous phase organic compounds; comprising the steps of contacting the gas with the organic compound dissolved in a gas scrubbing liquid.

2. The method in accordance with claim 1, wherein the organic compound is from the group containing acrylamides, organo-thiols, macrocyclic ligands or derivatives thereof.

3. The method in accordance with claim 1, wherein the gas is passed through a gas scrubbing liquid modified with the organic compound.

4. The method in accordance with claim 1, wherein a gas scrubbing liquid amended with the organic compound is sprayed through the gas.

5. The method in accordance with claim 1, wherein the organic compound amended gas scrubbing liquid is recycled after initial contact with the gas and contacted again with the gas.

6. The method in accordance with claim 1, wherein the solid precipitate formed by the organic compound, in the gas scrubbing liquid modified with the organic compound, after initial contact with the gas, is removed and the remaining modified scrubbing liquid is contacted again with the gas.

7. The method in accordance to claim 1, wherein the gas scrubbing liquid modified with the organic compound requires an activator to remove elemental mercury.

8. The method in accordance to Sub-CLAIM 7, wherein the activator is any metal that binds with the organic compound, and causes a precipitate to form in the gas scrubbing liquid.
